(19) United States
(12) Patent Application Publication
(10) Pub. No.: US 2022/0281068 A1
(43) Pub. Date: Sep. 8, 2022

(54) OSCILLATING TOOL DUST COLLECTION SHROUD

(71) Applicant: DUSTLESS DEPOT, LLC, Price, UT (US)

(72) Inventor: Kendall Hansen, Price, UT (US)

(73) Assignee: DUSTLESS DEPOT, LLC, Price, UT (US)

(21) Appl. No.: 17/190,275

(22) Filed: Mar. 2, 2021

(51) Int. Cl. B24B 55/10; B23D 59/00; B23Q 11/00

(52) U.S. Cl. CPC B24B 55/105; B23D 59/006; B23Q 11/0046

(57) ABSTRACT

A dust collection shroud for an oscillating tool is provided. The dust collection shroud includes a shroud body with a base and semi-circular dust collection plenums which extends around the output shaft of an oscillating tool. Left and right airflow ducts extend upwardly from the dust collection plenums around the sides of the oscillating tool head. The airflow ducts join together above the oscillating tool. A vacuum port connects the dust collection shroud to a vacuum to collect dust generated while using the dust collection shroud. The dust collection openings and airflow ducts are configured to provide greater airflow from adjacent the front of the oscillating tool in combination with balanced airflow around the sides and back of the oscillating tool; allowing the shroud to be used with various cutting and sanding bits.

### THE FIELD OF THE INVENTION

The present invention relates to dust collection. In particular, examples of the present invention relates to a dust collection shroud for collecting dust generated from use of a handheld oscillating sanding and cutting tool.

### BACKGROUND

Dust collection has become increasingly important both for commercial use and construction as well as for consumer or hobbyist use of power tools. Without adequate dust collection while working, dust and debris is typically scattered over a wide area. It is desirable to contain the dust and debris which is created while using power tools for several reasons. It is desirable to contain the dust and debris to keep the workplace cleaner and to minimize the time necessary to clean up afterwards. It is also desirable to contain the dust and debris to keep the debris from getting into the tool itself, as the fine dust often causes premature failure of the tool bearings, motor, etc. Additionally, dust poses a health risk to the machine operator and others who may breathe it. It is thus desirable to collect the dust to minimize exposure to the dust.

### BRIEF DESCRIPTION OF THE DRAWINGS

Non-limiting and non-exhaustive examples of the present invention are described with reference to the following figures, wherein like reference numerals refer to like parts throughout the various views unless otherwise specified.

FIG. 1 is a drawing which shows an isometric view of the dust shroud on an oscillating tool.

FIG. 2 is a drawing which shows an isometric view of the dust shroud on an oscillating tool.

FIG. 3 is a drawing which shows an isometric view of the dust shroud on an oscillating tool.

FIG. 4 is a drawing which shows an isometric view of the dust shroud on an oscillating tool.

FIG. 5 is a drawing which shows an isometric view of the dust shroud.

FIG. 6 is a drawing which shows an isometric view of the dust shroud.

FIG. 7 is a drawing which shows a front view of the dust shroud.

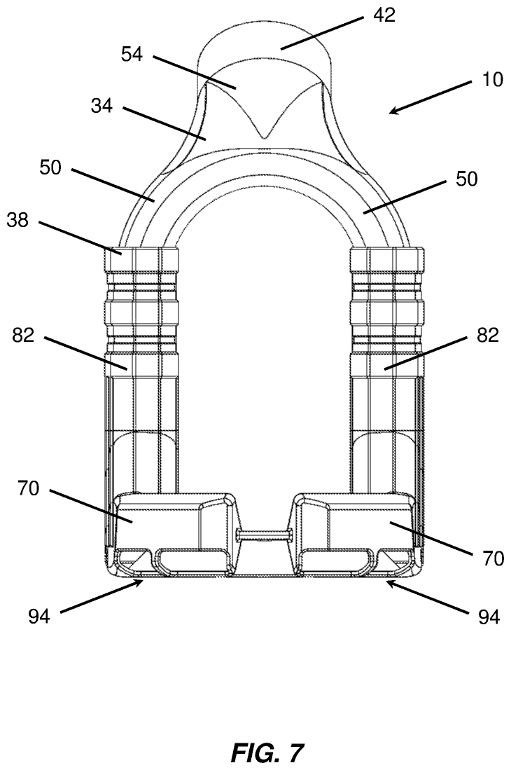

FIG. 8 is a drawing which shows a rear view of the dust shroud.

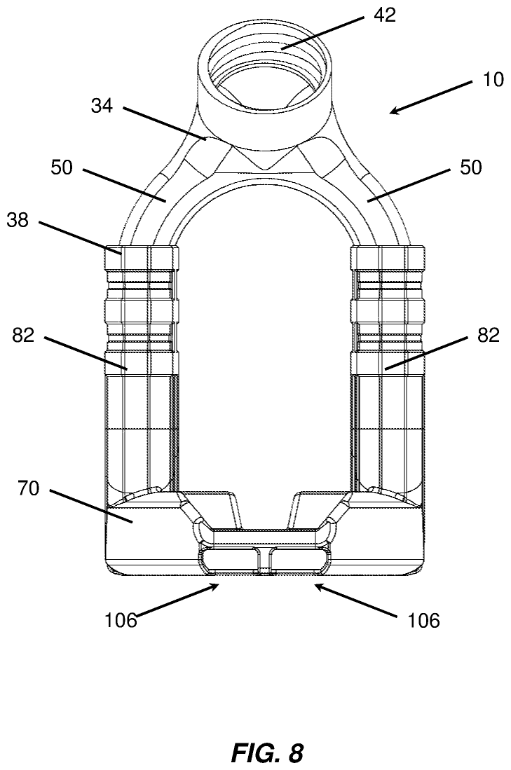

FIG. 9 is a drawing which shows a top view of the dust shroud.

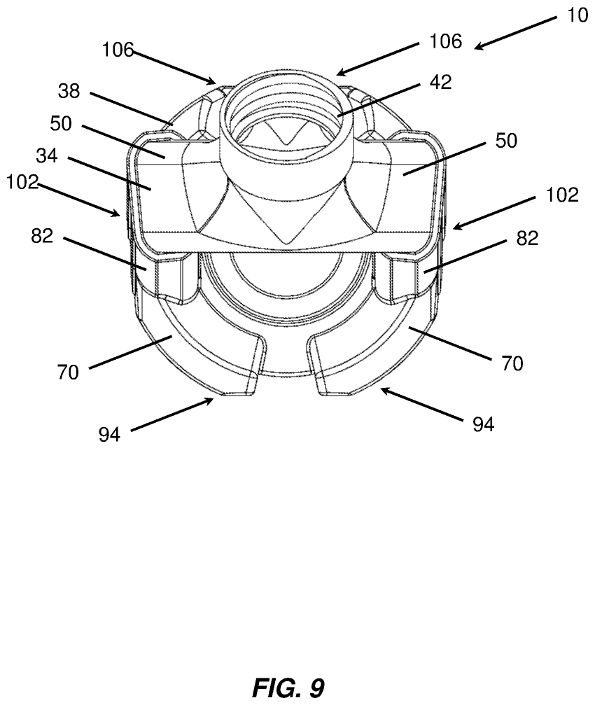

FIG. 10 is a drawing which shows a bottom view of the dust shroud.

FIG. 11 is a drawing which shows a left side view of the dust shroud.

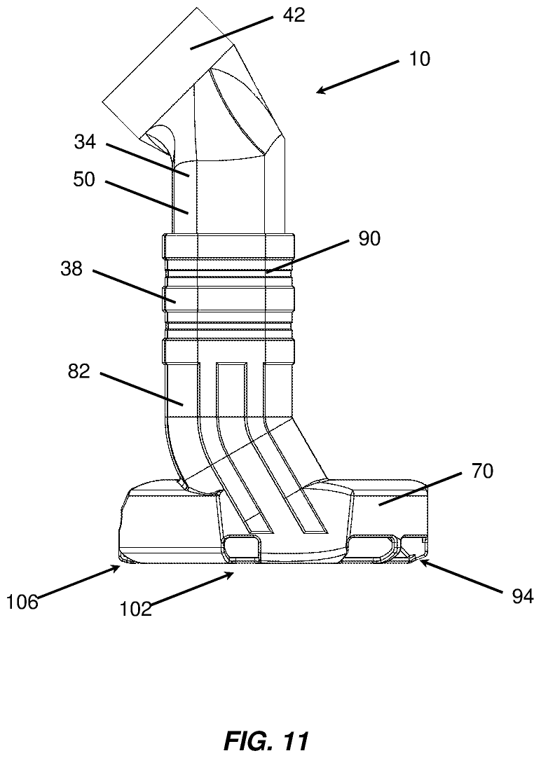

FIG. 12 is a drawing which shows a right side view of the dust shroud.

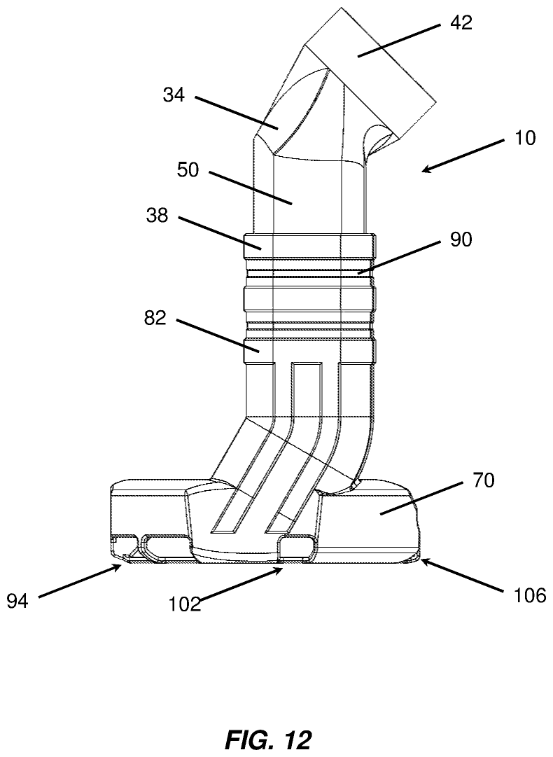

FIG. 13 is a drawing which shows a front view of the dust shroud on an oscillating tool.

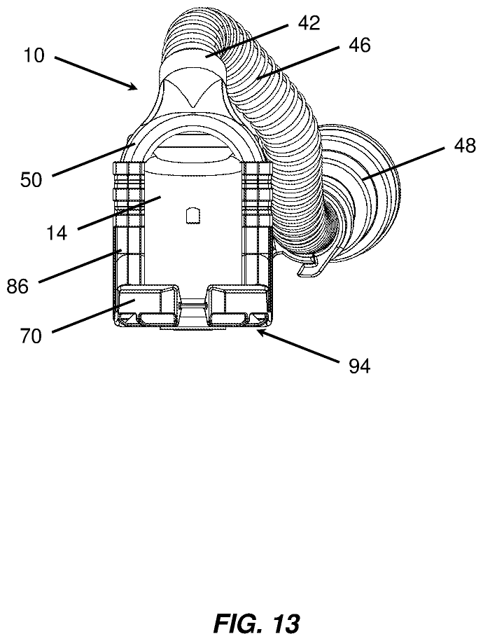

FIG. 14 is a drawing which shows a rear view of the dust shroud on an oscillating tool.

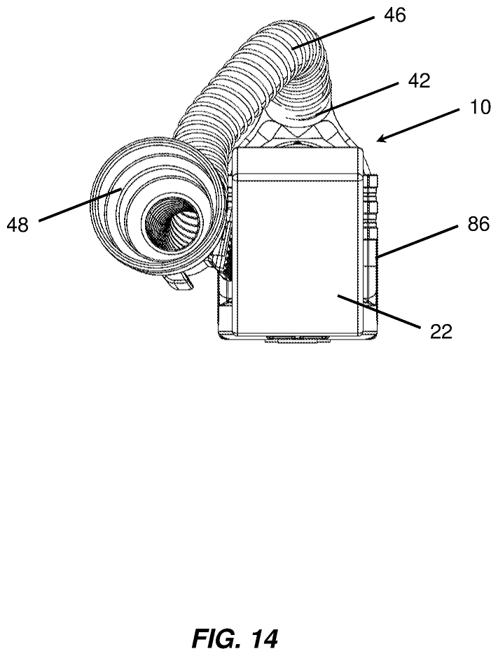

FIG. 15 is a drawing which shows a top view of the dust shroud on an oscillating tool.

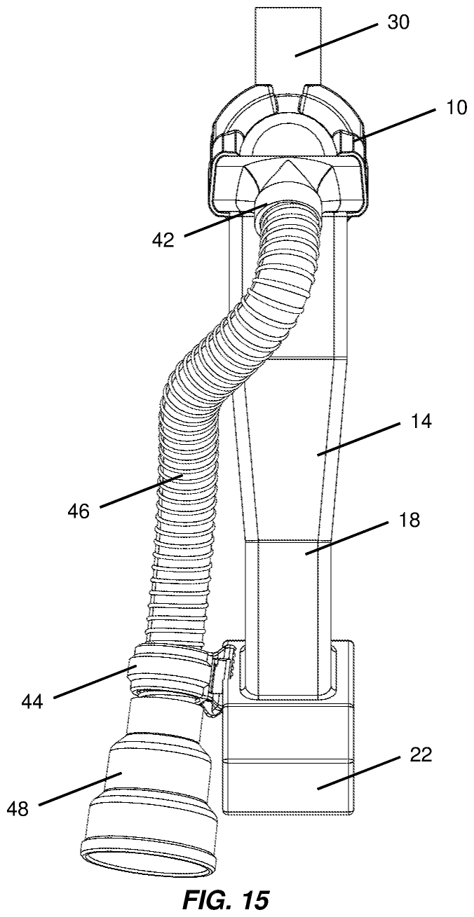

FIG. 16 is a drawing which shows a bottom view of the dust shroud on an oscillating tool.

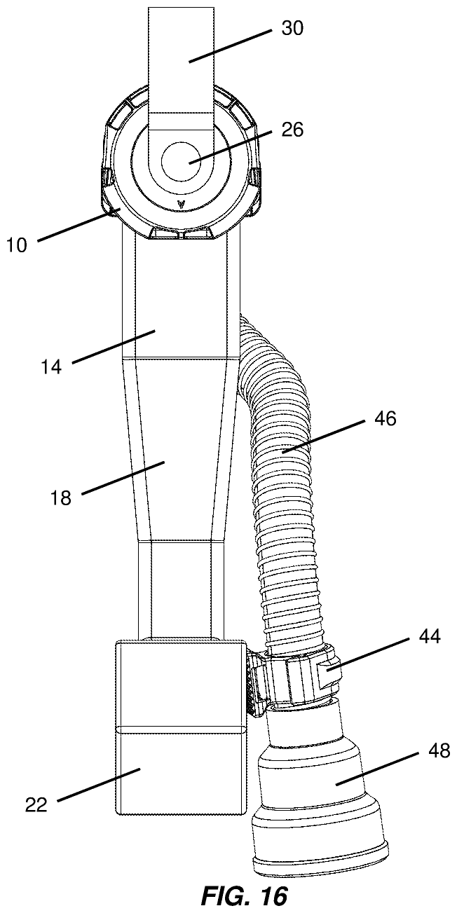

FIG. 17 is a drawing which shows a left side view of the dust shroud on an oscillating tool.

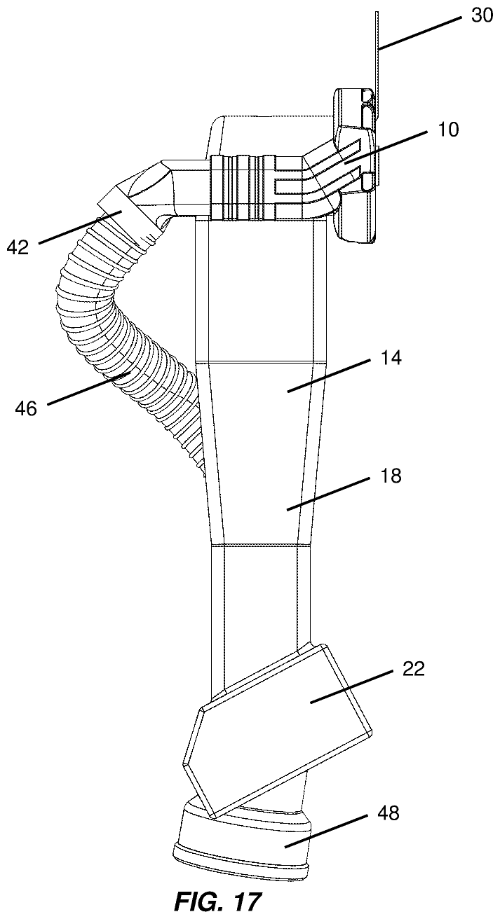

FIG. 18 is a drawing which shows a right side view of the dust shroud on an oscillating tool.

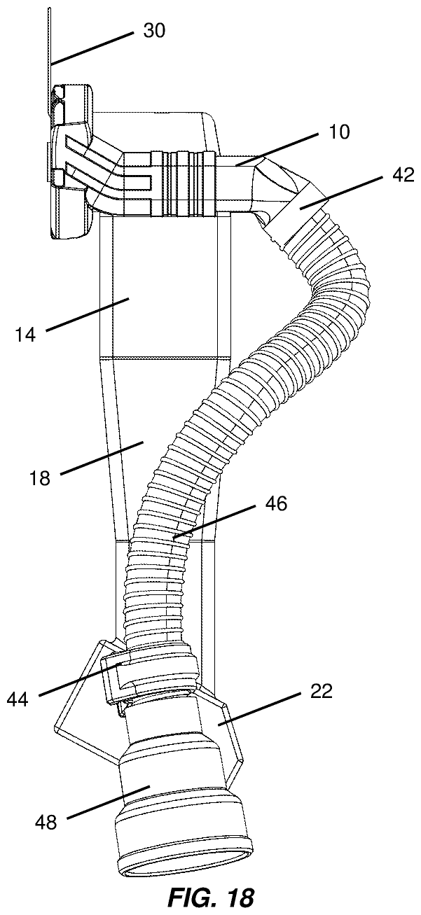

Corresponding reference characters indicate corresponding components throughout the several views of the drawings. Unless otherwise noted, the drawings have been drawn to scale. Skilled artisans will appreciate that elements in the figures are illustrated for simplicity and clarity. For example, the dimensions of some of the elements in the figures may be exaggerated relative to other elements to help improve understanding of various examples of the present invention. Also, common but well-understood elements that are useful or necessary in a commercially feasible embodiment are often not depicted in order to facilitate a less obstructed view of these various embodiments of the present invention.

It will be appreciated that the drawings are illustrative and not limiting of the scope of the invention which is defined by the appended claims. The examples shown each accomplish various different advantages. It is appreciated that it is not possible to clearly show each element or advantage in a single figure, and as such, multiple figures are presented to separately illustrate the various details of the examples in greater clarity. Similarly, not every example need accomplish all advantages of the present disclosure.

### DETAILED DESCRIPTION

In the following description, numerous specific details are set forth in order to provide a thorough understanding of the present invention. It will be apparent, however, to one having ordinary skill in the art that the specific detail need not be employed to practice the present invention. In other instances, well-known materials or methods have not been described in detail in order to avoid obscuring the present invention.

In the above disclosure, reference has been made to the accompanying drawings, which form a part hereof, and in which are shown by way of illustration specific implementations in which the disclosure may be practiced. It is understood that other implementations may be utilized and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, such feature, structure, or characteristic may be used in connection with other embodiments whether or not explicitly described. The particular features, structures or characteristics may be combined in any suitable combination and/or sub-combinations in one or more embodiments or examples. It is appreciated that the figures provided herewith are for explanation purposes to persons ordinarily skilled in the art.

As used herein, “adjacent” refers to near or close sufficient to achieve a desired effect. Although direct contact is common, adjacent can broadly allow for spaced apart features.

As used herein, the singular forms “a,” and, “the” include plural referents unless the context clearly dictates otherwise.

As used herein, the term “substantially” refers to the complete or nearly complete extent or degree of an action, characteristic, property, state, structure, item, or result. For example, an object that is “substantially” enclosed would mean that the object is either completely enclosed or nearly completely enclosed. The exact allowable degree of deviation from absolute completeness may in some cases depend on the specific context. However, generally speaking the nearness of completion will be such as to have the same overall result as if absolute and total completion were obtained. The use of “substantially” is equally applicable when used in a negative connotation to refer to the complete or near complete lack of an action, characteristic, property, state, structure, item, or result. For example, a composition that is “substantially free of” particles would either completely lack particles, or so nearly completely lack particles that the effect would be the same as if it completely lacked particles. In other words, a composition that is “substantially free of” an ingredient or element may still actually contain such item as long as there is no measurable effect thereof.

As used herein, the term “about” is used to provide flexibility to a number or numerical range endpoint by providing that a given value may be “a little above” or “a little below” the number or endpoint.

The disclosure describes a dust collection shroud for an oscillating sanding and cutting tool. The dust collection shroud may be universally adapted to fit many different oscillating tools and may be used with both cutting and sanding attachments without changing the dust collection shroud. The dust collection shroud attaches around the head of the oscillating tool and provides a dust collection chamber which extends around the base of the oscillating tool. The dust collection shroud has two dust collection passages which extend upwardly around left and right sides of the head of the oscillating tool and connect the dust collection chamber to a vacuum port located above the head of the oscillating tool. The dust collection chamber includes a combination of front, side, and back dust collection openings around the base of the dust collection chamber. This array of dust collection openings provides adequate dust collection for both sanding and cutting attachments used with the oscillating tool.

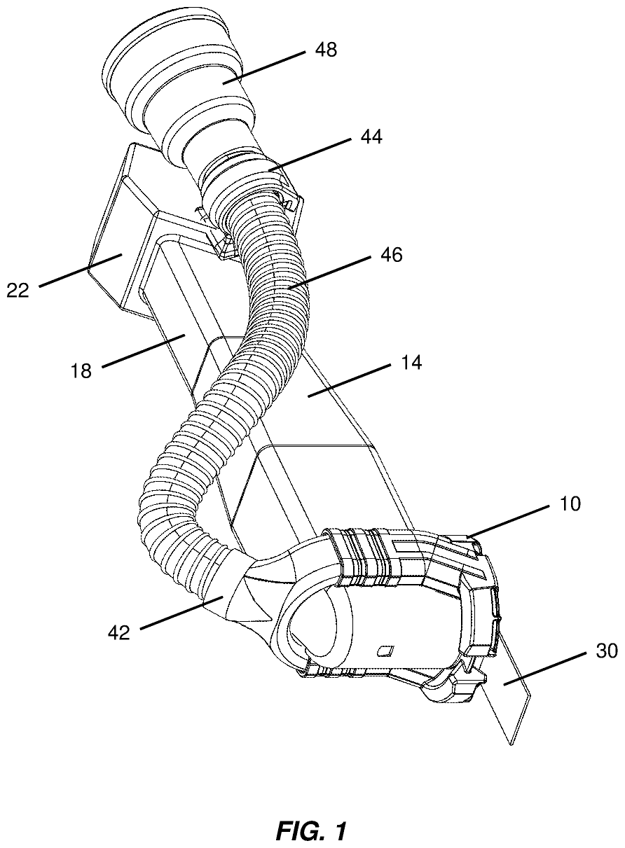

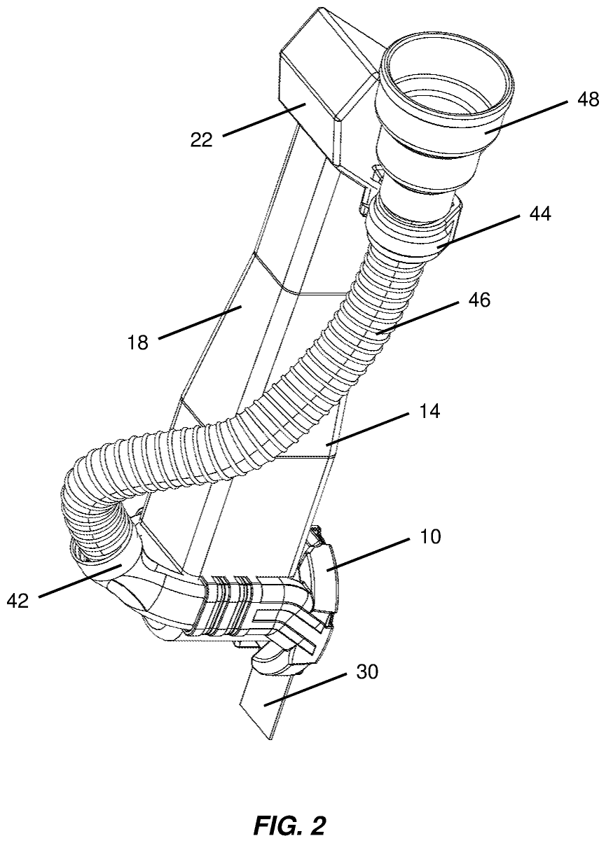

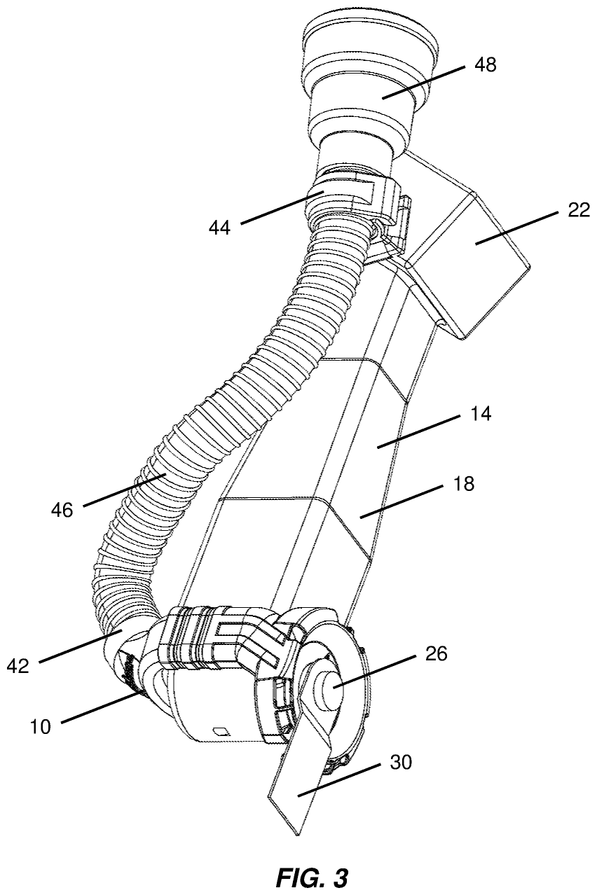

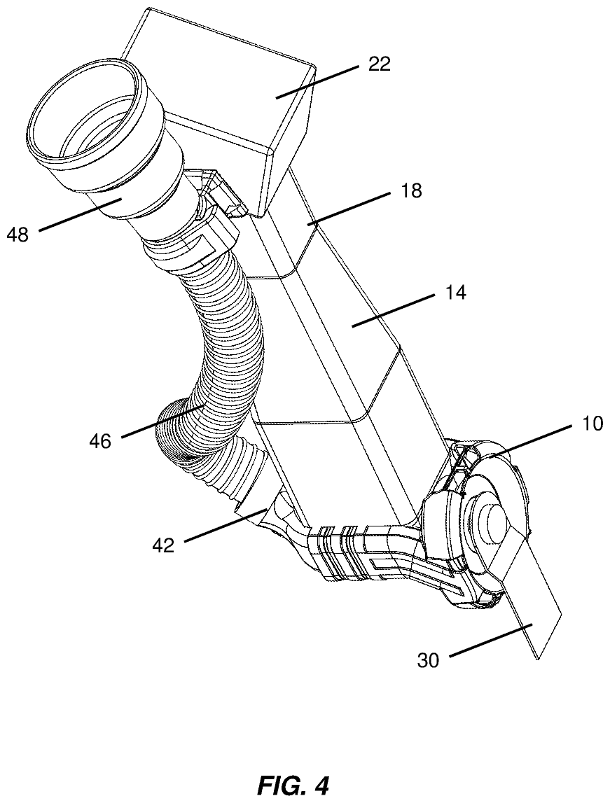

Referring now to FIGS. 1 through 4, the dust collection shroud 10 is shown attached to an example oscillating tool 14. Oscillating tools 14 are constructed with an elongate body 18 which houses the motor and drive of the tool and provides a hand grip for users. The body 18 is often rectangular or cylindrical in cross-sectional shape and is generally linear in shape between the front and back ends of the body. The oscillating tool 18 may be powered by connection to building mains power by a cord or by a battery and accordingly may include a battery 22 at the proximal end of the body 18. A motor, switch, and other components are housed within the body 18 as are necessary to create a functional oscillating tool 14. The distal, front end, or head of the body 18 houses a drivetrain which connects the motor to an output shaft 26 (FIG. 3). The axis of the output shaft 26 is oriented vertically (top to bottom) relative to the body and is oriented perpendicular to the body. The drivetrain converts the rotary motion of the motor to a small amplitude and high frequency angular oscillating motion of the output shaft. The output shaft 26 rotates back and forth around its axis by about 3 degrees, causing a cutting or sanding bit 30 to correspondingly rotate back and forth by about 3 degrees. A cutting bit 30 is attached to the output shaft 26 beneath the body and rotates back and forth with the output shaft 26 to cut or sand a desired workpiece.

In practice, users may use an oscillating tool 14 for a variety of different purposes throughout a day. The small amplitude oscillation of the bit 30 makes it easy to control the tool as compared to a conventional rotary or reciprocating blade. Additionally, the small amplitude oscillation of the bit 30 means that the bit 30 does not extend or cut appreciably beyond the desired area. In contrast, a reciprocating saw often requires one to two inches of clearance beyond the cut area to accommodate the linear oscillating movement of the cutting blade. Accordingly, workers often use oscillating tools for a variety of purposes throughout the day.

The dust collection shroud 10 is compatible with a large number of different brands of oscillating tools 14 and is also compatible with a large number of cutting or sanding attachments for the oscillating tools 14. Accordingly, a user does not need to change or adjust the dust collection shroud 10 after initial installation onto the tool 14. Compatibility with the various cutting and sanding bits that a user may use encourages compliance in using the dust collection shroud 10 by minimizing worker inconvenience.

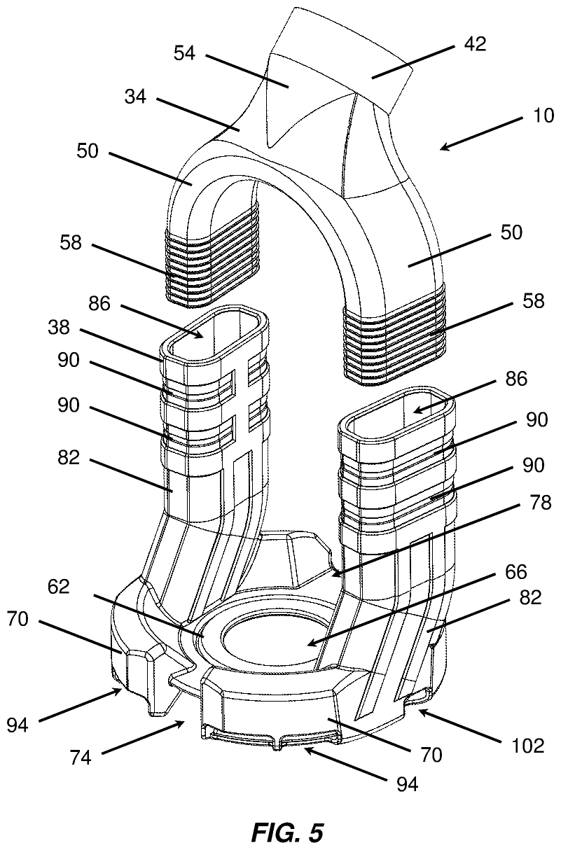

FIG. 5 shows a perspective view of the dust collection shroud 10. The shroud 10 includes an upper body section 34 and a lower body section 38. The upper section 34 attaches to the lower section 38 during assembly of the shroud 10. The upper shroud section 34 includes a vacuum port 42 which may be connected to a vacuum hose or section of intermediate hose 46 as shown in FIGS. 1 through 4. The vacuum port 42 is often sized to receive a nominal 1.25 inch vacuum hose or a similarly sized intermediate hose 46. The upper section includes left and right side upper ducts 50 which are separated laterally and which extend downwardly from the top of the upper section 34. The two ducts 50 are hollow and each include an airflow passage therethrough. As shown, the ducts 50 have a cross section which is generally oval, or which is a rectangular shape with rounded corners. The ducts 50 have walls of uniform thickness and the internal airflow passage has a shape which is similar to the outside shape of the ducts 50. The upper section 34 of the shroud 10 defines an internal airflow passage with a shape which is similar to the overall shape of the upper section 34; having two airflow passages joining together into a central plenum and connecting to a cylindrical opening at the vacuum port 42.

The upper section 34 includes a central body portion 54 which joins the ducts 50 to the vacuum port 42. The central body portion 54 is also hollow and forms a central plenum which joins the lumen of the vacuum port 42 and the airflow passages through the two ducts 50.

The two ducts 50 curve inwardly towards each other and form an arch shape as they join into the central body portion 54. The bottom portion of the ducts 50 include a vertical series of registration bumps 58 formed on the outside of the ducts 50. As shown, the registration bumps 58 are formed as a series of vertically spaced ridges extending around the ducts 50.

The lower portion 38 of the shroud 10 includes a base plate 62. The base plate 62 is generally planar and includes a center output shaft opening 66. In use, the oscillating tool output shaft 26 passes through the center opening 66. The shroud 10 includes two dust collection plenums 70 positioned on either side of the base plate 62 and on either side of the center opening 66. The dust collection plenums 70 are semi-circular in shape and are positioned on left and right sides of the shroud 10 around the periphery of the base plate 62. A front gap 74 and a rear gap 78 are located between the front ends and rear ends of the dust collection plenums 70. Left and right airflow ducts 82 extend generally vertically from the left and right dust collection plenums 72. The left and right airflow ducts 82 are generally oval in cross section and have a generally uniform wall thickness; forming left and right airflow passages 86 through the left and right airflow ducts 82. The left and right airflow passages 86 are connected to the cavities in the left and right dust collection plenums 70. The left and right airflow ducts 82 both include a lower section adjacent the left and right dust collection plenums 70 which angle backwardly towards the back of the oscillating tool 14 when the dust collection shroud 10 is attached to the tool 14. The upper sections of the left and right airflow ducts 82 extend vertically from the lower sections of the ducts.

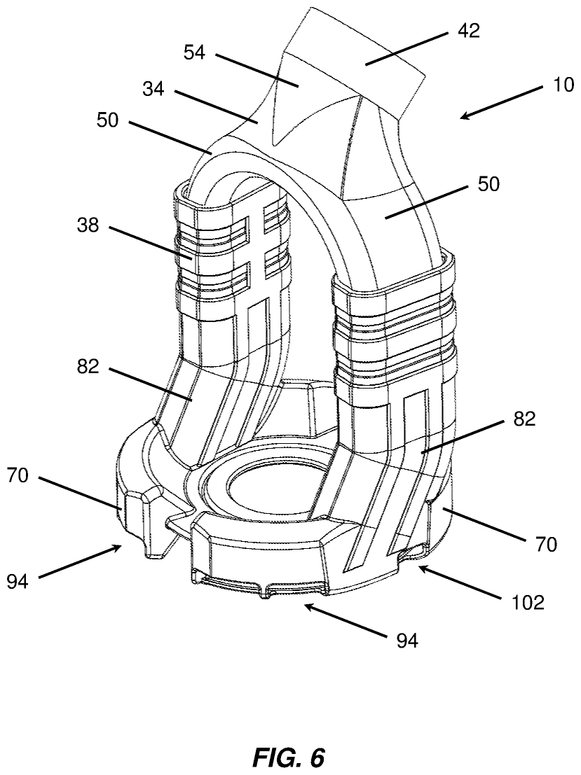

The left and right airflow passages 86 have a cross-sectional shape which is complementary to the outside shape of the left and right upper airflow ducts 50. The left and right lower airflow ducts 82 include bumps/ridges which extend inwardly into the airflow passages 86 on the inner side walls of the airflow ducts. The ridges engage the ridges 58 formed on the outside of the upper airflow ducts 50 to secure the left and right upper airflow ducts 50 inside of the respective left and right lower airflow ducts 82. The left and right lower airflow ducts may also include cut guides 90 which allow a user to easily cut the lower ducts 82 to reduce their height and allow the shroud 10 to better fit some oscillating tools 14 which have a smaller head section. FIG. 6 shows a perspective view of the shroud 10 with the upper section 34 and the lower section 38 in an assembled configuration.

The dust collection shroud is typically formed from a semi-flexible thermoplastic. This provides sufficient flexibility to allow some flexing of the upper airflow ducts 50 and lower airflow ducts 82 during installation of the dust collection shroud 10 onto an oscillating tool 14 while maintaining sufficient strength and rigidity during operation of the oscillating tool 14.

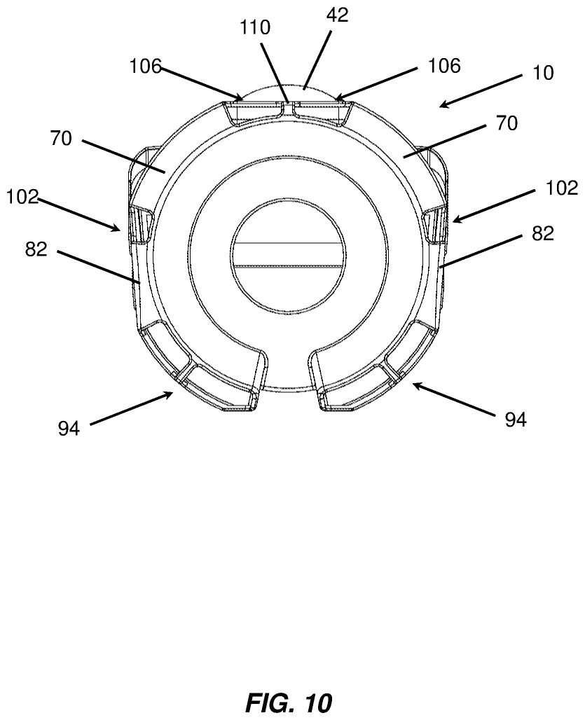

FIG. 10 shows a bottom view of the shroud 10. The left and right dust collection plenums 70 each include a large front dust collection opening 94. The front dust collection openings 94 may each include a brace 98 which extends between the side wall of the dust collection plenum 70 and the bottom of the dust collection plenum 70 and which divides the front dust collection opening 94 into two adjacent openings 94. The left and right dust collection plenums 70 also include a side dust collection opening 102 and a back dust collection opening 106. The side dust collection openings 102 are positioned behind the center of the lower airflow ducts 82 and, in the example shown, are positioned adjacent the back of the lower airflow ducts 82. This rearward positioning of the side dust collection openings 102 lowers the airflow through the side dust collection openings 102. A dividing wall 110 may be positioned between the two back dust collection openings 106. The dividing wall extends towards the center of the base plate 62 and separates the left and right dust collection plenums 70. The dividing wall 110 strengthens the rear portion of the shroud 10.

The front dust collection openings 94 are the largest dust collection openings. The back dust collection openings 106 are approximately one half as large as the front dust collection openings 94 by area. The side dust collection openings 102 are approximately one third as large as the front dust collection openings 94 by area. The dust collection openings 94, 102, 106 are located on both the bottom and the outer peripheral side walls of the dust collection plenums 70 so as to intake air both from beneath the oscillating tool 14 and from peripherally around the oscillating tool 14.

In use, a user places the lower shroud section 38 in position over the bottom of the oscillating tool head so that the output shaft 26 of the oscillating tool 14 extends through the lower opening 66. The left and right lower airflow ducts 82 extend upwardly along the left and right sides of the head of the oscillating tool 14. The user then places the upper portion 34 of the shroud 10 over the head of the oscillating tool 14 from the top of the oscillating tool 14 and inserts the left and right upper airflow ducts 50 into the respective left and right lower airflow ducts 82 until the central body portion 54 of the upper section 34 engages the top of the head of the oscillating tool 14. The ridges in the interior of the left and right lower airflow ducts 82 engage the ridges 58 on the outside of the left and right upper airflow ducts 50 as the upper section is connected to the lower section 38 and the external bumps/ridges 58 and internal bumps/ridges engage each other to hold the shroud 10 in the assembled position around the oscillating tool 14. A hose mount 44 may be attached to the body of the oscillating tool 14 with double stick tape, adhesive backed hook and loop fastener, or more preferably a length of hook and loop fastener strap which passes through the base of the hose mount 44 and around the oscillating tool body 18. The hose mount 44 includes a rounded receiver section and a clamp which together receive and secure a vacuum hose or intermediate hose 46 to the body 18 of the oscillating tool 14. The user attaches a vacuum hose (not shown) to the vacuum port 42 or to the hose adapter 48/intermediate hose 46 and secures the vacuum hose or the intermediate hose 46 with the hose mount 44. The user may then install a working bit 30 and use the oscillating tool to cut or sand a workpiece while collecting the generated dust and debris with the dust collection shroud 10 and a vacuum.

The example configuration of dust collection openings, airflow ducts, and dust collection plenums creates a beneficial distribution of airflow around the bottom of the dust collection shroud 10. The backwardly angled lower sections of the lower airflow ducts 82 increase the airflow from the fronts of the left and right dust collection plenums 70 with a smaller fraction of the airflow coming from the rear of the left and right dust collection plenums 70. The larger front dust collection openings 94 also result in a larger airflow into the front dust collection openings 94 compared to the side dust collection openings 102 and the rear dust collection openings 106. Overall, a majority of the air flow into the dust collection shroud 10 is through the front dust collection openings 94. The side dust collection openings 102 are smaller than the rear dust collection openings 106 to promote airflow through the rear dust collection openings 106 which are farther away from the lower airflow ducts 82. Placement of the side dust collection openings 102 near the back of the lower airflow ducts 82 and angling the lower section of the lower airflow ducts towards the back of the shroud 10 lowers the airflow through the side dust collection openings 102.

Overall, the dust collection shroud 10 intakes more air from the front of the shroud 10 via the front dust collection openings 94 and balances the remainder of the intake air through the side dust collection openings 102 and the rear dust collection openings 106. The increased air intake through the front dust collection openings 94 is beneficial when using a working bit 30 such as a saw blade which primarily cuts in front of the oscillating tool 14. The dust collection shroud 10 captures most of the dust and debris generated by this use. The intake airflow around the back and sides of the dust collection shroud 10 are sufficient to capture the dust generated when using a working bit 30 such as a sanding pad which frequently generates dust around all sides of the cutting bit 30. The design of the dust collection shroud 10 allows it to be installed once onto an oscillating tool and does not require further adjustment or modification while using the oscillating tool with different cutting or sanding bits. Accordingly, a user is not inconvenienced by the dust collection shroud 10 and use compliance is encouraged.

The above description of illustrated examples of the present invention, including what is described in the Abstract, are not intended to be exhaustive or to be limiting to the precise forms disclosed. While specific examples of the invention are described herein for illustrative purposes, various equivalent modifications are possible without departing from the broader scope of the present claims. Indeed, it is appreciated that specific example dimensions, materials, etc., are provided for explanation purposes and that other values may also be employed in other examples in accordance with the teachings of the present invention.

What is claimed is:

1. A dust collection shroud for a hand held oscillating tool comprising an elongate body having a head, an output shaft located at the head and oriented transverse to the elongate body, and a working bit attached to the output shaft and operated by the oscillating tool to rotate back and forth by a few degrees at a high frequency, the dust collection shroud comprising:
a base;
a left dust collection plenum disposed on a left side of the base;
a dust collection opening in the left dust collection plenum;
a right dust collection plenum disposed on a right side of the base;
a dust collection opening in the right dust collection plenum;
a left airflow duct attached to the left dust collection plenum and extending upwardly from the left dust collection plenum;
a right airflow duct attached to the right dust collection plenum and extending upwardly from the right dust collection plenum;
a central body portion joining the left and right airflow ducts together;
a vacuum port disposed in communication with the left and right upper airflow ducts;
wherein, when the dust collection shroud is installed onto an oscillating tool, the left dust collection plenum and the right dust collection plenum are positioned adjacent left and right sides of an oscillating tool output shaft and the left airflow duct and the right airflow duct extend upwardly along left and right sides of a head of an oscillating tool.

2. The dust collection shroud of claim 1, wherein, when the dust collection shroud is installed onto an oscillating tool, the vacuum port is positioned above a top of the oscillating tool.

3. The dust collection shroud of claim 1, the left dust collection plenum comprises a front dust collection opening, a side dust collection opening, and a rear dust collection opening, and wherein the right dust collection plenum comprises a front dust collection opening, a side dust collection opening, and a rear dust collection opening.

4. The dust collection shroud of claim 3, wherein the left rear dust collection opening has an area which is approximately one half an area of the left front dust collection opening, and wherein the right rear dust collection opening has an area which is approximately one half an area of the right front dust collection opening.

5. The dust collection shroud of claim 4, wherein the left side dust collection opening has an area which is approximately one third an area of the left front dust collection opening, and wherein the right side dust collection opening has an area which is approximately one third an area of the right front dust collection opening.

6. The dust collection shroud of claim 1, wherein the left airflow duct comprises a lower section which extends upwardly and backwardly from the left dust collection plenum, and wherein the right airflow duct comprises a lower section which extends upwardly and backwardly from the right dust collection plenum.

7. The dust collection shroud of claim 6, wherein the left side dust collection opening is positioned adjacent a rear of the left airflow duct, and wherein the right side dust collection shroud opening is positioned adjacent a rear of the right airflow duct.

8. The dust collection shroud of claim 6, wherein the left airflow duct comprises an upper section which extends upwardly from the lower section, and wherein the right airflow duct comprises an upper section which extends upwardly from the lower section.

9. The dust collection shroud of claim 1, wherein the dust collection shroud comprises an upper body section and a lower body section, wherein the upper body section is attachable to the lower body section; wherein the lower body section comprises:
a left lower airflow duct which is attached to the left dust collection plenum; and
a right lower airflow duct which is attached to the right dust collection plenum; and
wherein the upper body section comprises:
a left upper airflow duct which is attachable to the left lower airflow duct; and
a right upper airflow duct which is attachable to the right lower airflow duct.

10. The dust collection shroud of claim 9, wherein the left upper airflow duct is insertable into an airflow passage of the left lower airflow duct and the right upper airflow duct is insertable into an airflow passage of the right lower airflow duct.

11. The dust collection shroud of claim 10, wherein the left upper airflow dust comprises a first bump formed on the outside thereof, wherein the left lower airflow duct comprises a second bump formed inside the left lower airflow passage, and wherein the first bump engages the second bump to thereby retain the left upper airflow duct inside of the left lower airflow duct.

12. The dust collection shroud of claim 1, wherein the left dust collection plenum is semi-circular in shape and wherein the right dust collection plenum is semi-circular in shape.

13. The dust collection shroud of claim 12, wherein, when the dust collection shroud is installed onto an oscillating tool, the left dust collection plenum and the right dust collection plenum are generally concentric to an oscillating tool output shaft.

14. A dust collection shroud for a hand held oscillating tool comprising an elongate body having a head, an output shaft located at the head and oriented transverse to the elongate body, and a working bit attached to the output shaft and operated by the oscillating tool to rotate back and forth by a few degrees at a high frequency, the dust collection shroud comprising:
a lower body section comprising:
a left dust collection plenum;
a dust collection opening in the left dust collection plenum;
a right dust collection plenum;
a dust collection opening in the right dust collection plenum;
a left lower airflow duct attached to the left dust collection plenum and extending upwardly from the left dust collection plenum;
a right lower airflow duct attached to the right dust collection plenum and extending upwardly from the right dust collection plenum;
an upper body section comprising:
a left upper airflow duct;
a right upper airflow duct;
a central body portion joining the left upper airflow duct and the right upper airflow duct together;
a vacuum port disposed in fluid communication with the left upper airflow duct and the right upper airflow duct;
wherein the upper body section is attachable to the lower body section by joining the left lower airflow duct and the left upper airflow duct and by joining the right lower airflow duct and the right upper airflow duct and, when the dust collection shroud is installed onto an oscillating tool, the left dust collection plenum and the right dust collection plenum are positioned adjacent left and right sides of an oscillating tool output shaft and the left airflow duct and the right airflow duct extend upwardly along left and right sides of a head of an oscillating tool.

15. The dust collection shroud of claim 14, the left dust collection plenum comprises a front dust collection opening, a side dust collection opening, and a rear dust collection opening, and wherein the right dust collection plenum comprises a front dust collection opening, a side dust collection opening, and a rear dust collection opening.

16. The dust collection shroud of claim 15, wherein the left rear dust collection opening has an area which is approximately one half an area of the left front dust collection opening, and wherein the right rear dust collection opening has an area which is approximately one half an area of the right front dust collection opening.

17. The dust collection shroud of claim 16, wherein the left side dust collection opening has an area which is approximately one third an area of the left front dust collection opening, and wherein the right side dust collection opening has an area which is approximately one third an area of the right front dust collection opening.

18. The dust collection shroud of claim 14, wherein the left lower airflow duct comprises a lower section which extends upwardly and backwardly from the left dust collection plenum, and wherein the right lower airflow duct comprises a lower section which extends upwardly and backwardly from the right dust collection plenum.

19. The dust collection shroud of claim 18, wherein the left side dust collection opening is positioned adjacent a rear of the left airflow duct, and wherein the right side dust collection shroud opening is positioned adjacent a rear of the right airflow duct.

20. The dust collection shroud of claim 14, wherein the left dust collection plenum is semi-circular in shape and wherein the right dust collection plenum is semi-circular in shape, and wherein, when the dust collection shroud is installed onto an oscillating tool, the left dust collection plenum and the right dust collection plenum are generally concentric to an oscillating tool output shaft.
